(19) United States
(12) Patent Application Publication
(10) Pub. No.: US 2006/0137126 A1
(43) Pub. Date: Jun. 29, 2006

(54) Wiper arm of a wiper device

(75) Inventors: Michael Schauble, Bietigheim-Bissingen (DE); Bruno Egner-Walter, Heilbronn (DE)

Correspondence Address: MATTHEW R. JENKINS, ESQ., 2310 FAR HILLS BUILDING, DAYTON, OH, 45419, US

(73) Assignee: Valeo Systemes D'Essuyage

(21) Appl. No.: 10/537,004

(22) PCT Filed: Nov. 21, 2003
(86) PCT No.: PCT/EP03/13063

§ 371 Date: Nov. 15, 2005

(30) Foreign Application Priority Data
Nov. 28, 2002 (DE) 102 55 576.1

(51) Int. Cl. B60S 1/40

(52) U.S. Cl. 15/250.32; 15/250.43

(57) ABSTRACT

The invention relates to a wiper arm of a wiper device comprising a coupling section for connecting a flat wiper blade, wherein the wiper arm is designed to be U-shaped in cross section at least in part, with a back and two side walls. The invention is characterized in that the coupling section comprises a stand-alone wall section of one side wall which protrudes beyond the back and the other side wall in the longitudinal direction, and a hinge pin attached to this wall section for receiving a connecting section of the wiper blade.

The invention relates to a wiper arm of a wiper device comprising a coupling section for connecting a flat wiper blade, wherein the wiper arm is designed to be U-shaped in cross section at least in part, with a back and two side walls.

Such a wiper arm is known from WO 00/73113 A1. The coupling section of such a wiper arm is very complicated to manufacture. Besides the wiper arm, the coupling section Is also designed to be U-shaped in cross section in the region in which a hinge pin is provided, said hinge pin running transversely to the longitudinal axis of the wiper arm. As a result, the coupling section is very complicated to produce in terms of manufacturing technology.

The coupling section of the wiper arm serves for connection to a flat wiper blade which comprises a wiper strip facing the windscreen to be wiped, at least one strip-like elongate support element, and a connecting section for connection to the coupling section. Such flat wiper blades, which do not have a cascade-type clip design, are becoming more widespread. They usually have a very flat and narrow design, and this entails considerable advantages.

It is an object of the present invention to provide a wiper arm comprising a coupling section to which flat wiper blades, as described in particular in WO 00/73113 A1, can be connected. The intention is for it to be possible for the coupling section of the wiper arm in this case to be manufactured in a simple manner in terms of manufacturing technology.

According to the invention, this object is achieved by a wiper arm of the type mentioned above in that the coupling section comprises a stand-alone wall section of one side wall which protrudes beyond the back and the other side wall in the longitudinal direction, and a hinge pin attached to this wall section for coupling to a connecting section of the wiper blade. It is advantageous here if the stand-alone wall section runs in the rectilinear extension of the side wall of which it forms part. The wall section is then consequently in the plane of the associated side wall.

This has the advantage that, compared to the closest prior art, the region of the coupling section on which the hinge pin is arranged is designed in a stand-alone manner with only one wall. As a result, manufacture is considerably simplified. Moreover, it is advantageous that the wiper arm, or the coupling section, is of narrower design than the coupling section of the closest prior art. As a result, any impairment of vision of the vehicle driver caused by the width of the wiper arm in the region of the coupling section can be minimized.

One advantageous embodiment of the invention is obtained when the back is designed to be wider in the transverse direction than the length of the hinge pin in the transverse direction. As a result, the central longitudinal axis of the wiper arm advantageously lies substantially above the central longitudinal axis of the wiper blade. Consequently, a wiper device can be produced which is of very narrow design when seen in plan view of the windscreen to be wiped and thus impairs the vehicle driver's vision only to a small extent.

It is advantageous if the back at least substantially covers a wiper blade arranged on the wiper arm. As a result, the part of the wiper blade which lies under the back of the wiper arm is protected.

A wiper device of very flat design is obtained if the wiper blade is arranged at least in part between the side walls of the wiper arm. Moreover, the wiper blade is protected as a result.

In another embodiment of the invention, it may be provided that the back is designed to be narrower in the transverse direction than the length of the hinge pin in the transverse direction. As a result, a wiper device can be produced which is of very flat design.

According to the invention, it may be provided that the coupling section comprises a projection which adjoins the back, is L-shaped in cross section and has a web extending transversely to the longitudinal direction and a stop formed parallel to the wall section. As a result, a connection to a wiper blade known from WO 00/73113 A1 is possible, said connection being simple to produce in terms of manufacturing technology. The web may run in the plane of the back.

According to the invention, it may be provided that the wiper blade in the assembled state is arranged laterally next to the wiper arm. Such a wiper blade has the advantage that it is of flat design. The wiper arm is advantageously designed in such a way that the hinge pin is riveted to the wall section, and this can be achieved in a simple manner in terms of manufacturing technology.

The abovementioned object is also achieved by a wiper device which comprises a wiper arm according to the invention and a flat wiper blade which can be connected to the coupling section of the wiper arm.

Further advantages and advantageous refinements of the invention can be found in the following description in which the invention is described and explained in more detail with reference to examples of embodiments shown in the drawing.

In the drawings:

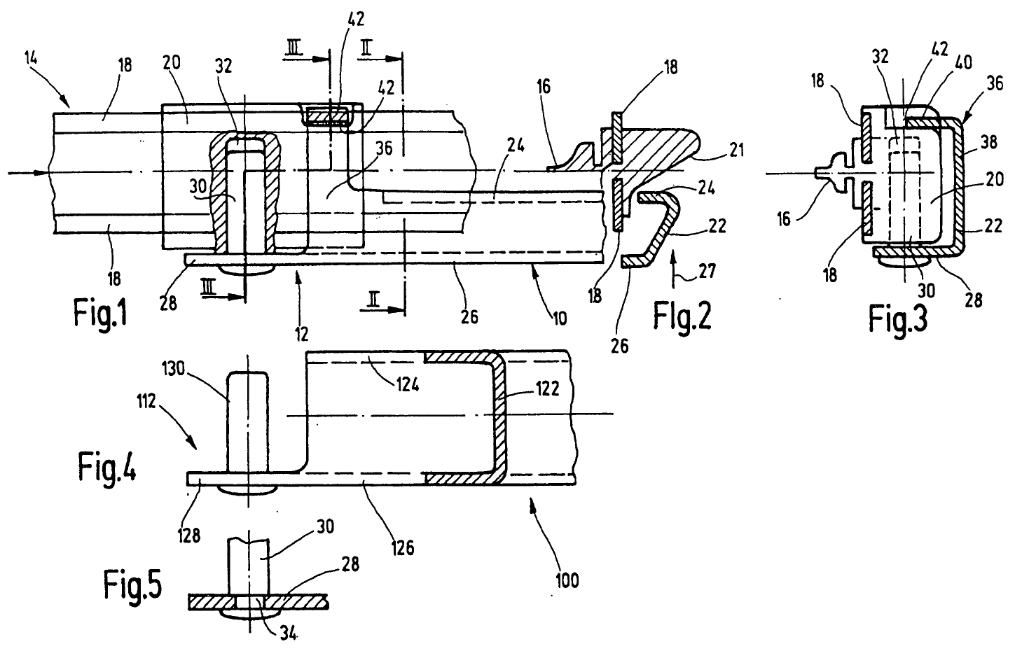

FIG. 1 shows a partial section of a plan view of a first wiper arm according to the invention;

FIG. 2 shows a section along line II;

FIG. 3 shows a section along line III;

FIG. 4 shows the plan view of a second wiper arm according to the invention; and

FIG. 5 shows a detailed diagram of the hinge pin of the wiper arm shown in FIGS. 1 and 4.

FIG. 1 shows a wiper arm 10 according to the invention, said wiper arm comprising a coupling section 12 for connection to a flat wiper blade 14 which is shown in part. The flat wiper blade 14 has a wiper strip 16, which faces the windscreen and is shown in FIGS. 2 and 3, two strip-like elongate support elements 18 and a connecting unit 20 connected to the support elements 18. A spoiler-like projection 21 is provided on the side facing away from the wiper strip 16.

As can be seen from FIG. 2, the wiper arm 10 is designed to be U-shaped in cross section and has a back 22 and two side walls 24 and 26. The back 22 nevertheless does not run at right angles to the side walls 24 and 26, but rather is slightly inclined in the direction 27 to the side from which the wind flows against the wiper arm 10.

The coupling section 12 comprises a stand-alone wall section 28, which protrudes beyond the back 22 and the side wall 24 in the longitudinal direction, and a hinge pin 30 which extends on the wall section 28 in the transverse direction. The hinge pin 30 engages in a seat 32 provided on the connecting unit 20, said seat being in the form of a blind hole. In the assembled state, the wiper blade 14 is arranged to pivot at least to a limited extent about the hinge pin 30.

As can be seen from FIG. 5, the hinge pin 30 is riveted to the wall section 28. To this end, the wall section 28 has a hole 28 and a bore 34.

Since the wall section 28 extends in the extension of the side wall 26, no separate manufacturing steps are required in order to form the wall section 28. As can be seen from FIG. 1, the wall section 28 lies in the plane of the side wall 26.

It can be seen from FIGS. 1 and 3 that the coupling section 12 has a projection 36 which adjoins the back 22 and is L-shaped in cross section as shown in FIG. 3. The L-shaped projection 36 in this case has a web 38 which extends transversely to the longitudinal direction and a stop 40 which is formed parallel to the wall section 28. In the assembled state, as shown in FIG. 1, the stop 40 cooperates with a counterstop 42 formed on the side of the connecting unit 20. As a result, transverse forces acting on the wiper blade 14 are deflected into the wiper arm 10. On the side facing away from the stop 42, the connecting unit 20 bears, at least in part and preferably substantially without play, against the wall section 28 which faces it.

As can be seen from FIG. 1, the back 22 is designed to be narrower in the transverse direction than the length of the hinge pin 30 in the transverse direction. As a result, the wiper blade 14 in the assembled state is arranged laterally next to the wiper arm 10, and therefore a wiper device which is of very flat design overall can be produced.

FIG. 4 shows a second embodiment of a wiper arm 100 according to the invention. The wiper arm 100 has a wall section 128 which corresponds to the wall section 28 of the wiper arm 10 and on which a hinge pin 130 is arranged by means of a riveted connection as shown in FIG. 5. The wall section 128 protrudes in a stand-alone manner beyond the two side walls 126 and 124 of the wiper arm, which wiper arm is designed to be U-shaped in cross section. In the case of the wiper arm 100 shown in FIG. 4, the back 122 of the wiper arm 100 is designed to be wider than the length of the hinge pin 130 in the transverse direction. As a result, a wiper blade that is to be arranged on the hinge pin 130 will be partially covered by the wiper arm 100. The wiper blade then lies between the two side walls 124 and 126. A wiper arm 100 comprising a coupling section 112 as illustrated has the advantage that it can be produced with minimal manufacturing outlay. To this end, a very narrow wiper device is produced which obstructs the vehicle driver only to an insignificant extent.

1. Wiper arm (10, 100) of a wiper device comprising a coupling section (12, 112) for connecting a flat wiper blade (14), wherein the wiper arm (10) is designed to be U-shaped in cross section at least in part, with a back (22) and two side walls (24, 26), characterized in that the coupling section (12, 112) comprises a stand-alone wall section (28) of one side wall (26) which protrudes beyond the back (22) and the other side wall (24) in the longitudinal direction, and a hinge pin (30) attached to this wall section (28) for coupling to a connecting section (20) of the wiper blade (14).

2. Wiper arm (100) according to claim 1, characterized in that the back (122) is designed to be wider in the transverse direction than the length of the hinge pin (130) in the transverse direction.

3. Wiper arm (100) according to claim 2, characterized in that the back (122) at least substantially covers a wiper blade arranged on the wiper arm (100).

4. Wiper arm (100) according to claim 2 or 3, characterized in that the wiper blade is arranged at least in part between the side walls (124, 126) of the wiper arm (100).

5. Wiper arm (10) according to claim 1, characterized in that the back (22) is designed to be narrower in the transverse direction than the length of the hinge pin (30) in the transverse direction.

6. Wiper arm (10) according to claim 5, characterized in that the coupling section (12) comprises a projection (36) which adjoins the back (22), is L-shaped in cross section and has a web (38) extending transversely to the longitudinal direction and a stop (40) formed parallel to the wall section (28).

7. Wiper arm (10) according to claim 5 or 6, characterized in that the wiper blade (14) in the assembled state is arranged laterally next to the wiper arm (10).

8. Wiper arm (10, 100) according to one of the preceding claims, characterized in that the hinge pin (30, 130) is riveted to the wall section (28, 128).

9. Wiper device comprising a wiper arm (10, 100) according to one of the preceding claims and a flat wiper blade (14) which can be connected to the coupling section.
